(19) United States
(12) Patent Application Publication
(10) Pub. No.: US 2026/0116626 A1
(43) Pub. Date: Apr. 30, 2026

(54) FEEDER CONTAINER WITH LID AND FEEDING BUCKET HAVING A MULTIPURPOSE HANDLE

(71) Applicant: Rubbermaid Commercial Products LLC, Atlanta, GA (US)

(72) Inventors: Brian Gregory Zesch, Mooresville, NC (US); Brian Wortham Downing, Charlotte, NC (US); William Adam Gralewski, Kalamazoo, MI (US)

(73) Assignee: Rubbermaid Commercial Products LLC, Atlanta, GA (US)

(21) Appl. No.: 19/366,816

(22) Filed: Oct. 23, 2025

Related U.S. Application Data
(60) Provisional application No. 63/714,737, filed on Oct. 31, 2024.

(51) Int. Cl. B65D 43/02; A01K 5/01; B65D 1/40; B65D 21/02; B65D 25/28

(52) U.S. Cl. CPC B65D 43/0225; A01K 5/0107; B65D 1/40; B65D 21/0222; B65D 25/2855

(57) ABSTRACT

A feed storage and feeding container for animals is provided. The container includes a housing and a lid that is couplable to the housing. The housing includes a number of engagement features and locking features that engage with corresponding features on the lid to securely connect the lid to the housing. The lid includes two sets of different ribs that have different thicknesses such that one set of ribs mate with the corresponding engagement features on the housing and the other set of ribs rests on the housing upper surface providing a secure arrangement of the lid to the housing. A feeding bucket for animals with a custom handle is also provided. The custom handle can be a single piece of metal with multiple bends designed such that the handle can be used to hang the feeding bucket on a nail or place the feeding bucket on a fence member.

### CROSS-REFERENCE TO RELATED APPLICATION

This application claims the benefit of U.S. Application No. 63/714,737, filed Oct. 31, 2024, the entirety of which is hereby incorporated by reference.

### TECHNICAL FIELD

The present disclosure relates generally to feed container for animals. Specifically, the embodiments of the present disclosure are related to a feed container with a lid and a feeding bucket with a multi-purpose handle.

### BACKGROUND

Conventional animal feed containers often come without a lid. In many instances, the animal feed is transferred from a storage container to a feed container in order to feed animals on a farm. These feed containers do not have a lid and are usually just open-faced bowls. Using feed containers without a lid can lead to several issues. First, containers without lids are more susceptible to pests like rodents, insects, birds, etc. that can contaminate the feed and cause losses for the farmer. Open containers can allow moisture to enter, leading to mold and fungi growth. This can spoil the animal feed and make it unsafe for the animals. Exposure to air and light can degrade the nutritional quality of the animal feed over time. Vitamins and other nutrients can break down, reducing the feed's effectiveness. Without lids, the feed can easily spill out, leading to waste and attracting more pests. Open containers are more affected by temperature changes, which can further impact the quality and shelf life of the feed. Feed containers having external latches are prone to be damaged by animals chewing on the exposed latch mechanism.

Traditional animal feeder buckets are either configured to be hung on a hook/nail or have plastic or metal hooks attached so that they can be hung over a fence member. There are no products on the market that combine both these aspects in a single handle that can be used either to hang the feeder bucket on a nail/hook or attach the bucket to a fence member.

### BRIEF DESCRIPTION OF THE DRAWINGS

FIG. 1 illustrates an exploded view of a feed container with lid in accordance with the principles of the present disclosure.

FIG. 2A illustrates a side view of the feed holder portion in accordance with the principles of the present disclosure.

FIG. 2B illustrates top view of the feed holder portion in accordance with the principles of the present disclosure.

FIG. 2C illustrates a bottom view of the feed holder portion in accordance with the principles of the present disclosure.

FIG. 2D illustrates a close-up view of the feed holder portion with the locking feature in accordance with the principles of the present disclosure.

FIG. 2E illustrates a close-up view of the locking feature in accordance with the principles of the present disclosure.

FIG. 3A illustrates a top view of the lid in accordance with the principles of the present disclosure.

FIG. 3B illustrates a bottom view of the lid in accordance with the principles of the present disclosure.

FIG. 3C illustrates a perspective view of the bottom of the lid in accordance with the principles of the present disclosure.

FIG. 3D illustrates a close-up view of the lid ribs in accordance with the principles of the present disclosure.

FIG. 3E illustrates a close-up view of the lid being secured to the feed holder portion in accordance with the principles of the present disclosure.

FIG. 4A illustrates a perspective view of a feeding bucket with a custom handle in accordance with the principles of the present disclosure.

FIG. 4B illustrates a side view of the feeding bucket with the custom handle in accordance with the principles of the present disclosure.

FIG. 4C illustrates a top view of the feeding bucket with the custom handle in accordance with the principles of the present disclosure.

FIG. 5A illustrates a perspective view of the custom handle for the feeding bucket in accordance with the principles of the present disclosure.

FIG. 5B illustrates a side view of the custom handle for the feeding bucket in accordance with the principles of the present disclosure.

FIG. 5C illustrates a front view of the custom handle for the feeding bucket in accordance with the principles of the present disclosure.

FIG. 6A illustrates the feeding bucket mounted on a fence member in accordance with the principles of the present disclosure.

FIG. 6B illustrates the position of the custom handle of the feeding bucket in relation to the fence member in accordance with the principles of the present disclosure.

FIG. 6C illustrates the feeding bucket mounted on a nail/hook in accordance with the principles of the present disclosure.

The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

The various embodiments of animal feeder containers described herein advantageously provide enhanced storage features and versatility. The present disclosure includes non-limiting embodiments of feeder containers for animals that include a feed storage and feeder container with a lid and feed bucket with a multipurpose handle that can be used to hang the feed bucket to a fence member or a nail/hook. The embodiments are described in detail herein to enable one of ordinary skill in the art to practice the feed container and the feed bucket, although it is to be understood that other embodiments may be utilized and that logical changes may be made without departing from the scope of the disclosure. Reference is made herein to the accompanying drawings illustrating some embodiments of the disclosure, in which use of the same reference numerals indicates similar or identical items. Throughout the disclosure, depending on the context, singular and plural terminology may be used interchangeably.

The meanings of the terms used herein will be apparent to one of ordinary skill in the art or will become apparent to one of ordinary skill in the art upon review of the detailed description when taken in conjunction with the several drawings and the appended claims.

Embodiments of the present disclosure include a feed container with a lid having housing that has a first end and a second end. The lid is couplable to the first end of the housing. The housing further includes a lip structure disposed at the first end of the housing, a plurality of locking structures disposed within the lip structure, a plurality of recessed regions disposed within the lip structure, and an engagement feature disposed within each of the plurality of the locking structures and the plurality of recessed regions. The lid includes a front surface and an opposing back surface. The lid also includes a set of first ribs extending between a ring structure and an edge of the lid and a set of second ribs extending between the ring structure and the edge of the lid. The set of first ribs is different from the set of second ribs. In one embodiment, the set of the first ribs each has a first end and an opposing second end and the second end is characterized by a first thickness. Furthermore, the set of the second ribs each has a third end and an opposing fourth end and the fourth end is characterized by a second thickness. In an embodiment, the second thickness is greater than the first thickness.

Other embodiments of the present disclosure provide a feeding bucket having a multipurpose handle. The feeding bucket includes a housing having a plurality of handle connection points and a handle connected to the plurality of handle connection points. The handle further includes a first curved portion that is attached to one of the plurality of handle connection points, a first elongated member that is coupled to the first curved portion, a second member that is coupled to the first elongated member, a third member that is coupled to the second member, a fourth member that is coupled to the third member, and a hook portion that is coupled to the fourth member. The first elongated member forms a first angle with the second member, and the second member is orthogonal to the third member. The handle also includes a fifth member that is coupled to the hook portion, a sixth member that is coupled to the fifth member, a seventh member that is coupled to the sixth member, a second elongated member that is coupled to the seventh member, and a second curved portion that is coupled to the second elongated member.

The present disclosure provides details on a specific type of feed container with lid and a feeding bucket with a multipurpose handle, but one skilled in the art will realize that other types of feed containers and feeding buckets may also be manufactured using the systems and methods provided in this disclosure.

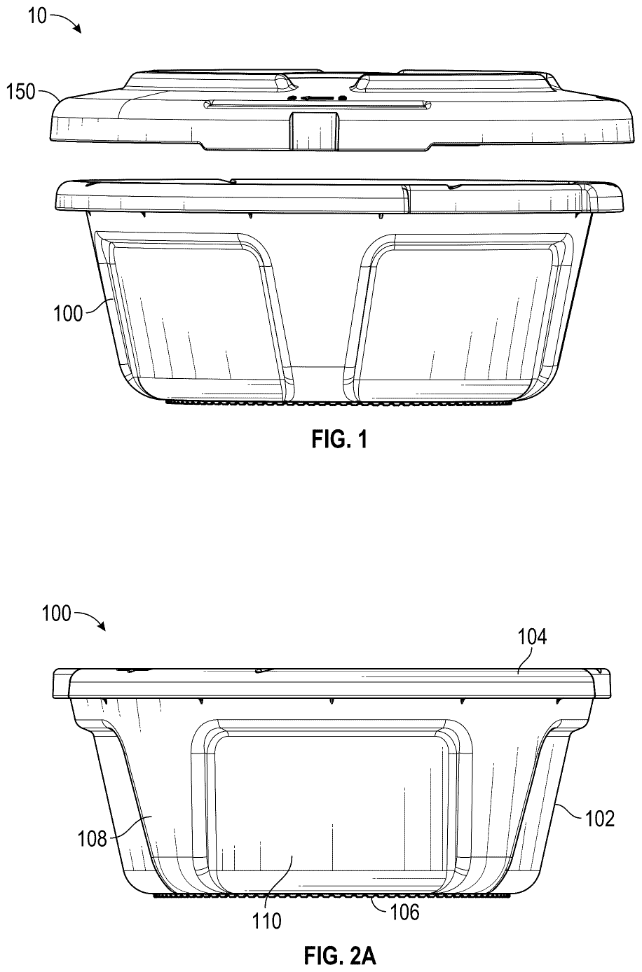

FIG. 1 illustrates an exploded view of a feed container with lid 10 in accordance with the principles of the present disclosure. The feed container with lid 10 includes a feed holder portion 100 and a corresponding lid 150. The feed holder portion 100 defines a housing that has a recessed chamber that can hold the animal feed. The lid 150 can sit atop the feed holder portion 100 and cover the opening of the feed holder portion 100. In an embodiment, the lid 150 can be secured to the feed holder portion 100 creating the closed and self-contained feed container with lid 10. In an embodiment, the feed container with lid 10 can be manufactured using plastic or polycarbonate material. In a specific embodiment, the feed container with lid 10 can be made from High-density polyethylene (HDPE) and/or polypropylene material. In other embodiments, the feed container with lid 10 can be made using rubber or metals such as galvanized steel or aluminum.

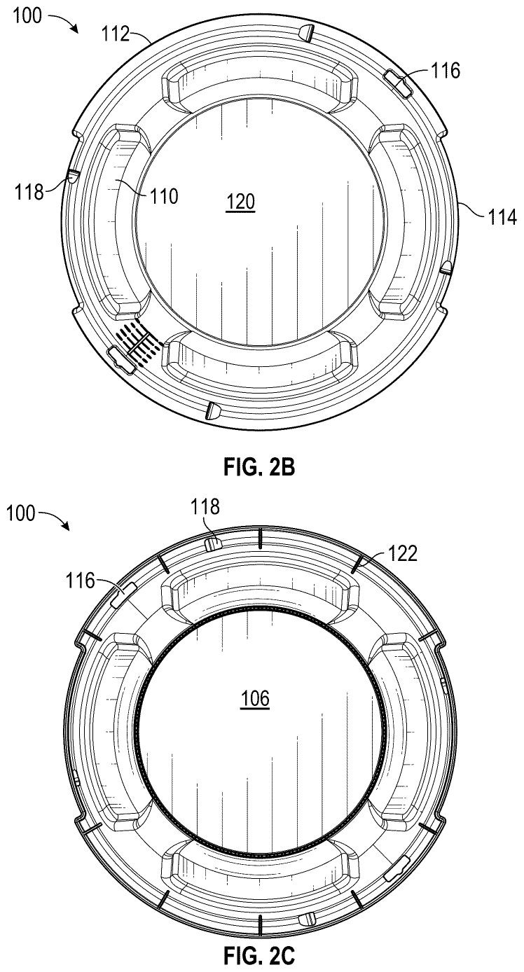

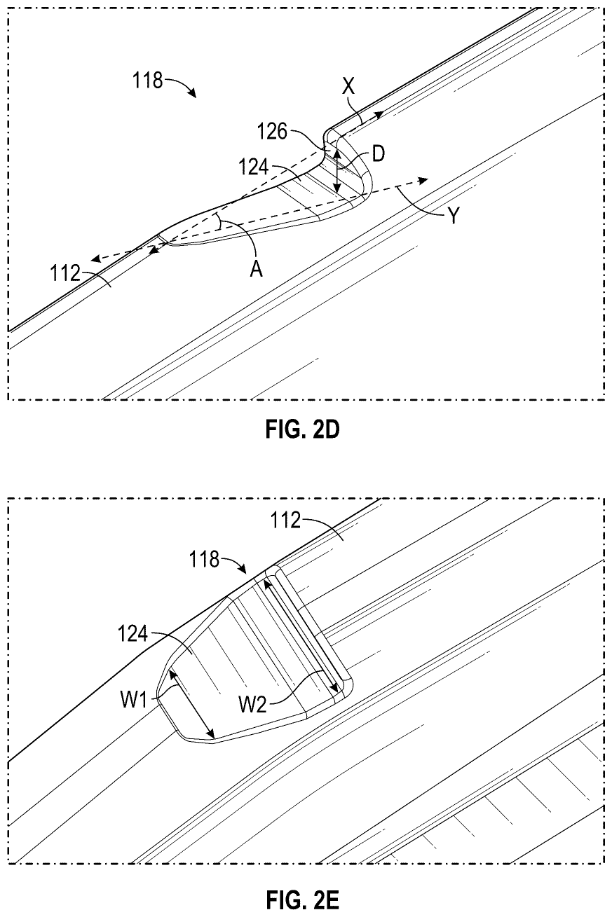

FIG. 2A illustrates a front view of the feed holder portion 100 in accordance with the principles of the present disclosure. While the feed holder portion 100 is shown as circular in shape, one skilled in the art will realize that other shapes for the feed holder portion 100 are also possible such as rectangular, polygonal, or the like. The feed holder portion 100 includes a housing structure 102 that has a height. An upper lip structure 104 is connected to the housing structure 102 and is disposed along the perimeter of the housing structure 102. The feed holder portion 100 further includes a bottom surface 106. The housing structure 102 along with the upper lip structure 104 and the bottom surface 106 together define a chamber that is capable of holding an amount of animal feed either in solid, semi-solid, or liquid form. The feed holder portion 100 also includes a plurality of pillar structures 108 that provide structural and mechanical rigidity to the feed holder portion 100. In between two consecutive pillar structures 108 there is a recessed region 110. In an embodiment, the thickness of the pillar structures 108 is greater than the thickness of the recessed region 110. Since the feed holder portion 100 is usually used in outdoor and harsh environments such as farms, stables, barns, etc. it is important that the feed holder portion 100 have sufficient mechanical rigidity and weight so as not to be damaged by the animals and/or the environment. The pillar structured 108 along with the recessed regions 110 provide the requisite structural rigidity and stability for use in such environments. The bottom surface 106 is substantially planar in order to enable the feed holder portion 100 to be placed on the ground.

FIG. 2B illustrates top view of the feed holder portion 100 in accordance with the principles of the present disclosure. The feed holder portion 100 has an interior bottom surface 120 that is opposite the exterior bottom surface 106. The interior bottom surface 120 forms the base of the feed holder portion 100. The upper lip portion 104 includes multiple features designed to secure the lid 150 to the feed holder portion 100. The upper lip portion 104 includes a plurality of arcuate locking structures 112. In a specific embodiment, the feed holder portion 100 includes two arcuate locking structures 112 that are located opposite each other. Two recessed regions 114 are located in between the two arcuate locking structures 112. The two recessed regions 114 are also disposed opposite each other. Each of the arcuate locking structure 112 includes an opening 116 therein. The openings 116 align with corresponding openings on the lid 150 when the lid 150 is secured to the feed holder portion 100. The opening 116 can be used to further secure the lid 150 and the feed holder portion 100 together or may be used to anchor the feed holder portion 100 to the ground for enhanced stability and a prevention against being tipped or otherwise moved from its intended location. While the openings 116 are shown as being rectangular, it is to be understood that other shapes for the opening 116 are within the scope of this disclosure.

The upper lip structure 104 also includes a plurality of engagement features 118. One engagement feature 118 each is located on each of the arcuate locking structure 112 and one engagement feature 118 each is located on each of the recessed regions 114, as illustrated in FIG. 2B. Details of the engagement feature 118 will be described in detail below with reference to FIGS. 2D and 2E. The engagement features 118 are configured to receive complimentary features on the lid 150 to secure the lid 150 to the feed holder portion 100. FIG. 2C illustrates a bottom view of the feed holder portion 100 in accordance with the principles of the present disclosure. Underneath each of the arcuate locking structures 112, a plurality of ribs 122 run along a width of the arcuate locking structure 112. The ribs 122 provide mechanical strength and rigidity to the arcuate locking structure 112 and also engage a portion of a corresponding locking structure on the lid 150.

FIGS. 2D and 2E illustrate a close-up view of the feed holder portion 100 with the engagement or locking feature 118 in accordance with the principles of the present disclosure. As illustrated in FIG. 2D, each locking feature 118 has a first portion 124 and a second portion 126. In an embodiment, the first portion 124 is disposed orthogonally to the second portion 126 and the second portion 126 is connected to the first portion 124 at one end of the first portion 124. The second portion 126 rises from the first portion 124 in a vertical direction by a distance ‘D’. In an embodiment, this distance D can be in the range of 1 to 50 millimeters. The first portion 124 has a gradient that increases from a first end of the first portion 124 to a second end of the portion 124. The gradient is the highest at the second end of the first portion 124 where it meets the second portion 126. Consider an axis ‘X’ that is along the upper surface of the arcuate locking structure 112 and an axis ‘Y’ that follows the gradient of the first portion 124. In an embodiment, the ‘X’ and the ‘Y’ axis form an angle ‘A’ that is in the range of 1 deg to 90 deg. When the lid 150 is placed over the feed holder portion 100, a corresponding structure of the lid 150 mates with and comes in contact with the first portion 124 and the second portion 126 of the locking feature 118.

FIG. 2E illustrates a top close-up view of the locking feature 118 according to an embodiment of the present disclosure. The first portion 124 is narrow at the first end and wider at the second end that connects to the second portion 126. In an embodiment, the width of the first portion ‘W1’ at the first end of the first portion 124 is less than the width ‘W2’ of the first portion 124 at the second end of the first portion 124. In an embodiment, W2 is between 10% and 50% greater than W1.

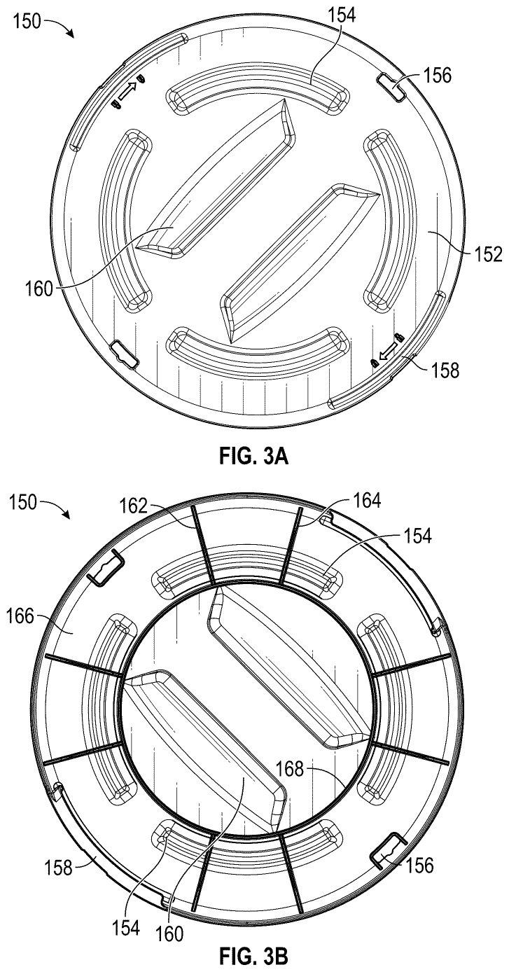

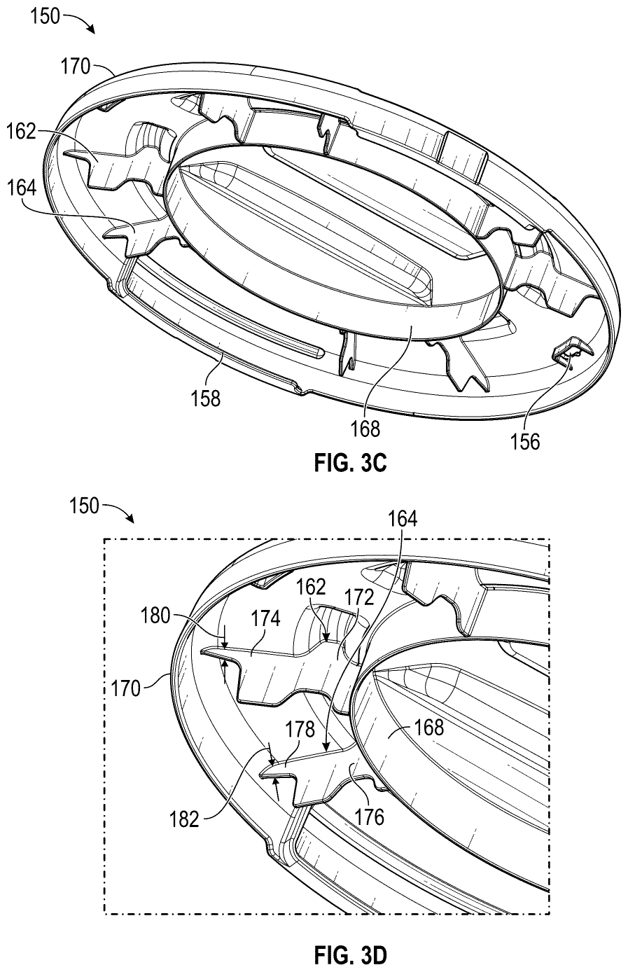

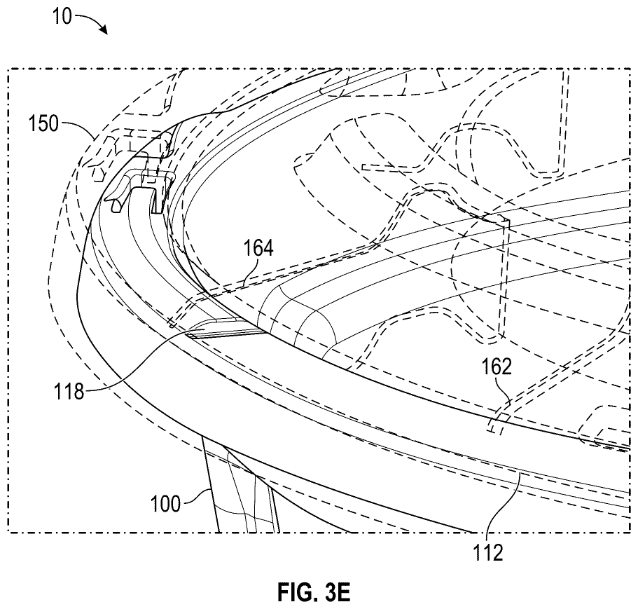

FIG. 3A illustrates a top view of the lid 150 in accordance with the principles of the present disclosure. The lid 150 includes a top surface 152. A plurality of features are disposed on the top surface 152. The top surface 152 includes a plurality of stacking features 154 arranged in a circular pattern. Each of the stacking feature 154 is arcuate in shape and rises vertically to a height above the top surface 152. In an embodiment, there are four stacking features 154 that are arranged in a circular pattern and together define a circular area within their periphery. In an embodiment, the bottom surface 106 of the feed holder portion 100 is designed to fit within the circular area defined by the stacking features 154. This enables multiple feed containers with lids 10 to be stacked on top of each other. A couple of handle structures 160 are located within the circular area defined by the stacking feature 154. The handle structures 160 each have a recessed region that enables a user to grab the lid 150 in order to either secure the lid 150 to the feed holder portion 100 or to remove the lid 150 from the feed holder portion 100. The lid 150 also includes a plurality of through openings 156 that run the thickness of the lid 150. Each of the through openings 156 align with the corresponding opening 116 in the feed holder portion 100 described above.

The lid 150 also includes a plurality of locking portions 158. A bottom side of each locking portion 158 slides over the corresponding recessed region 114 of the feed holder portion 100 when the lid 150 is engaged with the feed holder portion 100. This helps with securing the lid 150 to the feed holder portion 100 and aligns the through opening 156 to the corresponding opening 116 of the feed holder portion 100. FIG. 3B illustrates a bottom view of the lid 150 in accordance with the principles of the present disclosure. The bottom portion of the lid 150 includes a plurality of first ribs 162 and a plurality of second ribs 164. The ribs 162 and 164 are similar but not identical in their structure as will be explained below. Each of the first ribs 162 and the second ribs 164 are arranged radially along the bottom surface of the lid 150. Each of the first ribs 162 and each of the second ribs 164 run from an edge of the lid 150 to a ring structure 168 located towards the center of the lid 150 on the bottom side of the lid 150. The ring structure 168 is located between the stacking feature 154 and the handles 160 on the bottom side of the lid 150. The ring structure 168 provides mechanical rigidity to the lid 150. None of the first ribs 162 or the second ribs 164 connect to any surface of the locking portions 158. The first ribs 162 and the second ribs 164 are arranged in a pair formation such that one of the first ribs 162 is disposed next to one of the second ribs 164 and they together form a pair of ribs. In an embodiment, the lid 150 has 4 pairs of ribs where each pair include one first rib 162 and one second rib 164. Each of the first ribs 162 and the second ribs 164 are arranged such that they pass underneath at least one stacking structure 154.

FIGS. 3C and 3D illustrate a close-up view of the bottom side of the lid 150 in accordance with the principles of the present disclosure. The ring structure 168 has a height and is placed concentrically with respect to the periphery or outer edge 170 of the lid 150. Each of the first ribs 162 has a first end 172 that is connected to the ring structure 168. The first rib 162 has an opposing second end 174 that is located towards the outer edge 170 of the lid 150. The second end 174 of the first rib 162 has a pointed shape and has a first thickness 180 as illustrated in FIG. 3D. Similarly, each of the second ribs 164 has a first end 176 connected to the ring structure 168 and an opposing second end 178 disposed towards the outer edge 170 of the lid 150. The second end 178 of the second rib 164 is defined by a second thickness 182. In an embodiment, the first thickness 180 is smaller than the second thickness 182. For example, the first thickness 180 can be in range the of 1-50 millimeters and the second thickness 182 can be in the range of 1-100 millimeters.

FIG. 3E a close-up view of the lid 150 being secured to the feed holder portion 100 in accordance with the principles of the present disclosure. It is to be noted that the lid 150 is shown as transparent in order to explain the relative positions of the various features of the lid 150 and the feed holder 100 when the lid is secured to the feed holder portion 100. In practice, the lid 150 may not be transparent. In operation, the lid is 150 is first placed over the feed holder portion 100 such that each of the recessed region 114 of the feed holder portion 100 is aligned with each of locking portion 158 of the lid 150. The lid 150 is then rotated clockwise by about a quarter turn to secure the lid 150 to the feed holder portion 100. In doing so, each of the first ribs 162 and each of the second ribs 164 also slide along the top surface of the arcuate locking structure 112 of the feed holder portion 100. When the lid 150 is rotated by the requisite amount, the second end 178 of each of the second ribs 164 sits within a corresponding locking feature 118 of the feed holder portion 100 and is in contact with the first portion 124 and the second portion 126 of the locking feature 118. Since the thickness of the second portion 178 of the second ribs 164 is larger than the thickness of the second portion 174 of the first ribs 162, the second portion 178 of the second ribs 164 is accommodated in the locking feature 118 due to the gradient of the first portion 124 described above. The second portion 126 of the locking feature 118 acts as a hard-stop and prevents any further movement of the lid beyond that point. In the secured state, the second end 174 of each of the first ribs 162 is in contact with the upper surface of the arcuate locking structure 112.

The feed container with lid 10 according to an embodiment of the present disclosure has many advantages. Since the lid can be secure to the container, there is less chance of rodents or other pests getting into the container and spoiling the feed. Since the locking mechanism is hidden (compared to exposed clamps or hinges), the feed container with lid 10 is less susceptible to damage by animals chewing on any portion of the locking mechanism. The use of ribs of two different thicknesses ensures easy and proper operation of the lid thereby making it easy for a user to lock or unlock the lid while making it very difficult for any animal or rodent to open the lid. Further the same feed container can be used for storage since it has a securable lid, and multiple feed containers can be stacked on top of each other.

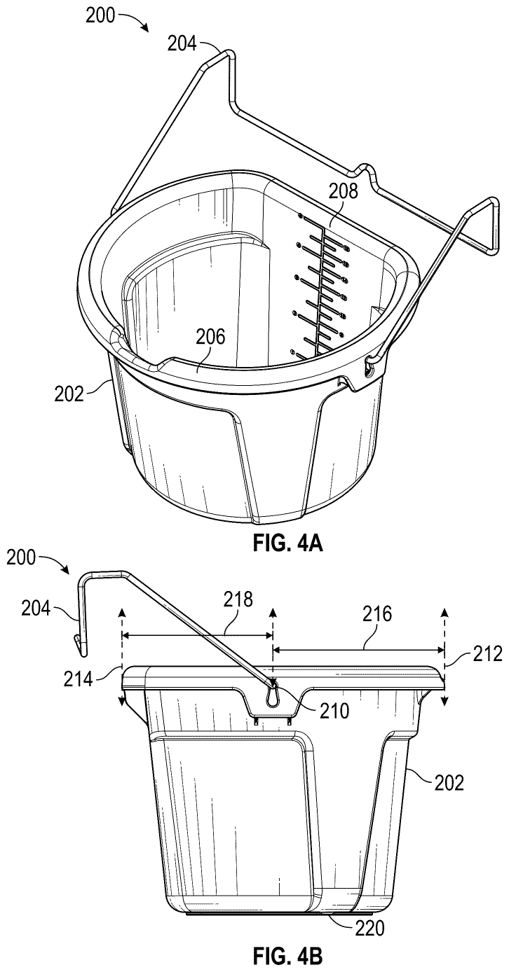

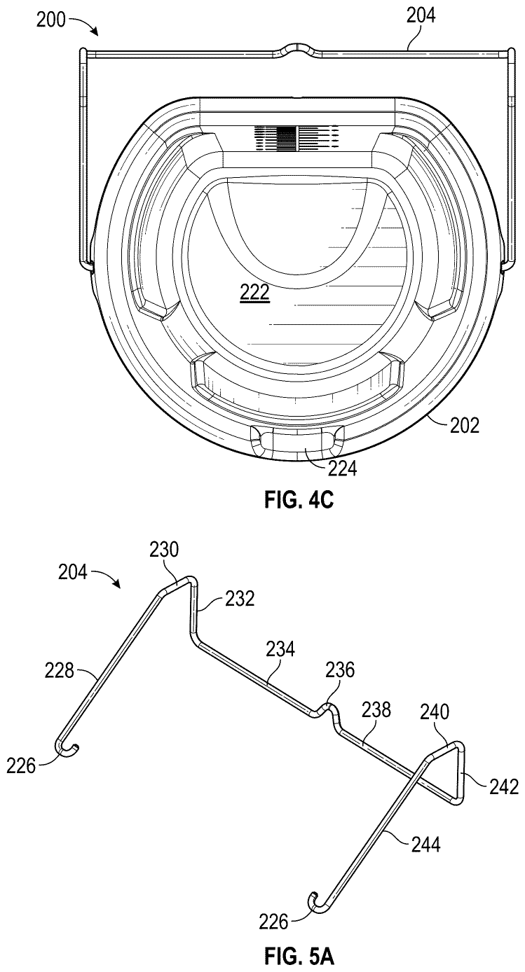

FIG. 4A illustrates a feeding bucket 200 in accordance with the principles of the present disclosure. The feeding bucket 200 includes a housing 202 that defines a chamber that can hold the animal feed. The feeding bucket 200 also includes a handle 204 that can be used to attach the feeding bucket to a variety of anchors such as a fence or a nail/hook. In an embodiment, the feeding bucket 200 includes a circular front portion 206 and a flat back portion 208. In other embodiments, the back portion 208 may also be circular. In an embodiment, the feeding bucket housing 202 may be manufactured using materials including plastic or polycarbonate material. In a specific embodiment, the feeding bucket housing 202 can be made from High-density polyethylene (HDPE) and/or polypropylene material. In other embodiments, the feeding bucket housing 202 can be made using rubber or metals such as galvanized steel or aluminum. In an embodiment, the handle 204 may be manufactured using metals such as galvanized steel or aluminum.

FIG. 4B illustrates a side view of the feeding bucket 200 in accordance with the principles of the present disclosure. The feeding bucket 200 further includes a substantially planar bottom surface 220. This helps to place the feeding bucket 200 on the ground or any other flat surface. The feeding bucket 200 includes at least two handle connection points 210 located on either side of the feeding bucket 200. The handle connection points 210 may be designed as slots or other suitable shape that can accept one end of the handle 204 and allow the handle to freely rotate along an arcuate path. The feeding bucket 200 may have a front end 214 and an opposing back end 214. In an embodiment, the front end 214 may correspond to the front portion 206 and the back end 214 may correspond the back portion 208. A farthest point on the front end 212 may be separated from a center of the handle connection point 210 by a first distance 216. Similarly, a farthest point on the back end 214 may be separated from the center of the handle connection point 210 by a second distance 218. In the embodiment where the back portion 208 of the feeding bucket 200 is flat, the first distance 216 may be larger in value than the second distance 218. The individual values of the first distance 216 and the second distance 218 depend on the size and capacity of the feeding bucket 200. For example, the first distance 216 for a feeding bucket 200 having a capacity of 3 gallons will be smaller than the first distance 216 for a feeding bucket 200 having a capacity of 5 gallons. In the embodiment where the back portion 208 of the feeding bucket 200 is also circular, the value of the first distance 216 may be equal to the value of the second distance 218. In an embodiment, the first distance 216 and/or the second distance 218 define a radius of the feeding bucket 200. In an embodiment, the first distance 216 and/or the second distance 218 influence the length of the handle 204 as the handle 204 has to be long enough so that the handle can clear the farthest point on either of the front end 212 or the back end 214 when the handle is rotated from the front to back and vice versa.

FIG. 4C illustrates a top view of the feeding bucket 200 with the custom handle in accordance with the principles of the present disclosure. The feeding bucket 200 includes a base surface 222 that is part of the feeding bucket housing 202. The distance between the base surface 222 and the top surface of the housing partially defines the capacity of the feeding bucket 200 in addition to the first distance 216 and the second distance 218. The feeding bucket 200 may also include a notch 224 located towards the front end 212 of the feeding bucket 200.

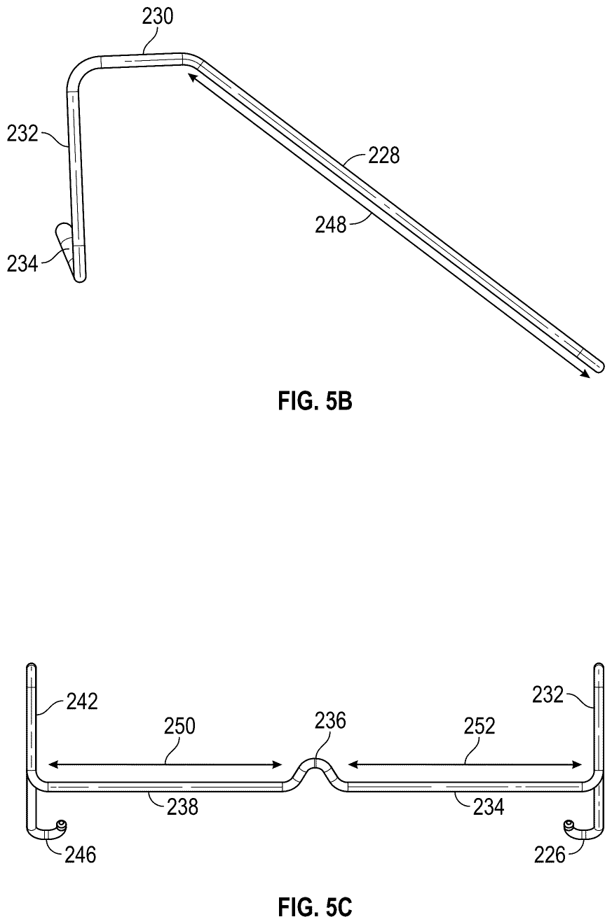

FIG. 5A illustrates a perspective view of the custom handle 204 for the feeding bucket 200 in accordance with the principles of the present disclosure. The handle includes a first hook/curved portion 226 and a second hook/curved portion 246. The first hook/curved portion 226 and the second hook/curved portion 246 are configured to be attached to the respective handle connection points 210 of the feeding bucket 200. In an embodiment, the first hook/curved portion 226 and the second hook/curved portion 246 are located at opposing ends of the handle 204. The handle 204 further includes a first elongated member 228 that is connected to the first curved portion 226 at a first end of the first elongated member 228. Similarly, a second elongated member 244 is connected to the second curved portion 246 at a first end of the second elongated member 244. The handle 204 further includes a third member 230 that is connected to the first elongated member 230 at a second end of the first elongated member 228 and fourth member 240 that is connected to the second elongated member 244 at a second end of the second elongated member 244. The first elongated member 228 forms a first angle with the third member 230. Similarly, the second elongated member 244 forms a second angle with the fourth member 240. In an embodiment, the second angle is same as the first angle. In an embodiment, the first angle can be between 0 deg and 90 deg. In an embodiment, the first elongated member 228 and the second elongated member 244 are configured to be attached to the bucket. The third member 230 and the fourth member 240 are configured to function as horizontal rest portions when the feed bucket is placed over a fence.

The third member 230 is further connected to a fifth member 232. In an embodiment the third member 230 is orthogonal to the fifth member 232 and forms an angle of 90 degrees with the fifth member 232. The fourth member 240 is connected to a sixth member 242. In an embodiment the fourth member 240 is orthogonal to the sixth member 242 and forms an angle of 90 degrees with the sixth member 242. The fifth member 232 is connected to a seventh member 234 and is orthogonal to the seventh member 234. The sixth member 242 is connected to an eighth member 238 and is orthogonal to the eight member 238. Both the seventh member 234 and eighth member 238 are connected to a hook portion 236 of the handle 204. Thus, the handle 204 is one continuous piece of material which includes all the aforementioned members and two curved portions. In an embodiment, the handle 204 can be manufactured using a metal extrusion process or a metal bending process. In an embodiment, the first curved portion 226, the first elongated portion 228, the third member 230, the fifth member 232, and the seventh member 234 are respective mirror images of the second curved portion 246, the second elongated member 244, the fourth member 240, the sixth member 242, and the eighth member 238. In an embodiment, (i) the first elongated portion 228 is parallel to the second elongated member 244, (ii) the third member 230 is parallel to the fourth member 240, and (iii) the fifth member 232 is parallel to the sixth member 242. The seventh member 234 and the eight member 238 are disposed along a same line. The fifth member 232 and the sixth member 242 are configured to function as vertical retentions when the feed bucket is placed over a fence.

FIG. 5B illustrates a side view of the custom handle 204 for the feeding bucket in accordance with the principles of the present disclosure. The side view shows a close-up view of the first elongated member 228, the third member 230, and the fifth member 232. The first elongated member 228 has a length 248. In an embodiment, the length 248 is greater than the first distance 216 and/or the second distance 218 illustrated in FIG. 4B above. This allows the handle 204 to freely rotate in an arcuate path without being obstructed by any portion of the bucket housing 202. The lengths of the third member 230 and the fifth member 232 are designed such that the handle can fit over any standard rectangular or circular fence member that is used on farms or other locations where animals are kept. FIG. 5C illustrates a front view of the custom handle 204 for the feeding bucket 200 in accordance with the principles of the present disclosure. As illustrated, the seventh member 234 may have a length 252 and the eight member 238 may have a length 250. In an embodiment, length 252 is equal to the length 250. Each of the lengths 250 and 252 are partially dependent on the size of the feeding bucket 200. For example, the length 250 for a feeding bucket 200 having a capacity of 3 gallons will be smaller than the length 250 for a feeding bucket 200 having a capacity of 5 gallons. In another embodiment, the length of the fifth member 232 may be the same as the length of the sixth member 242.

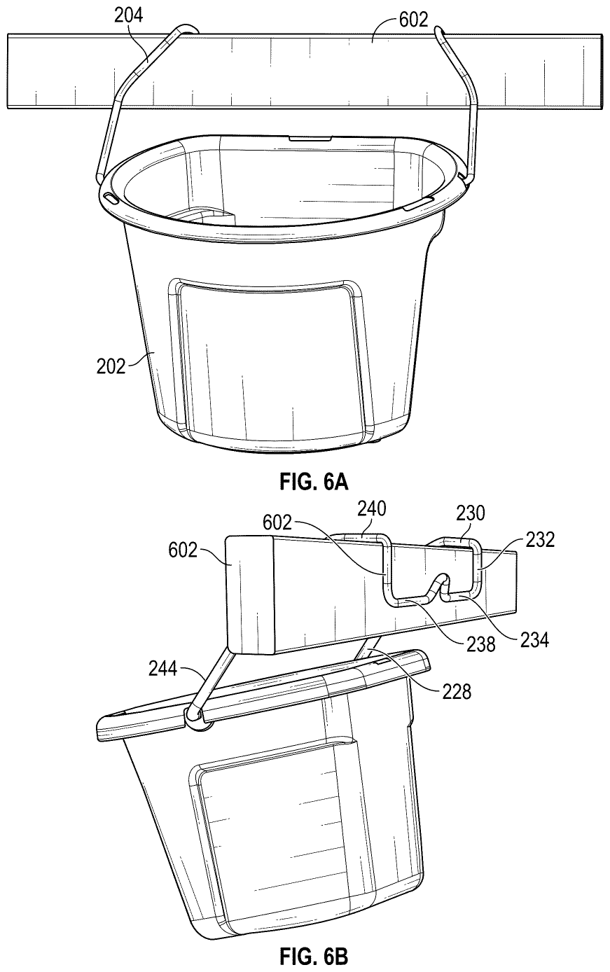

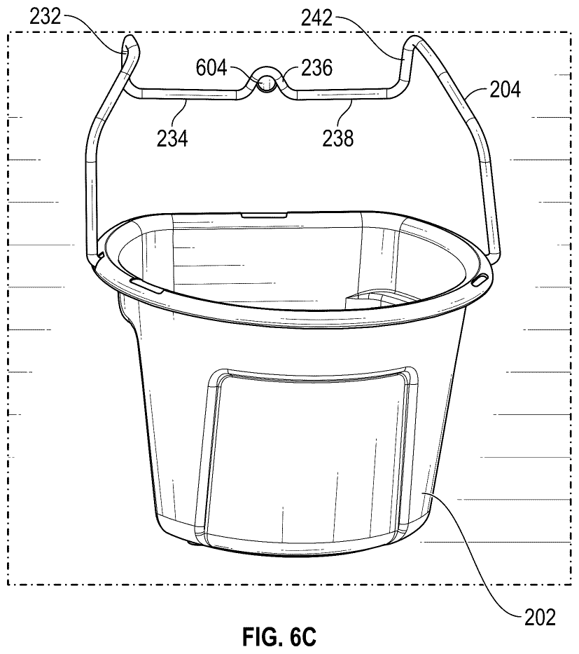

FIGS. 6A and 6B illustrate the feeding bucket 200 mounted on a fence member 602 in accordance with the principles of the present disclosure. As illustrated, in operation, the handle 204 is placed over the rectangular fence member 602 such that a portion of the handle 204 is located behind the fence member 602. Specifically, when the feeding bucket 200 is placed over the rectangular fence member 602, the third member 230 and the fourth member 240 are in contact with a first surface of the fence member 602. The fifth member 232 and the sixth member 242 are in contact with a second surface of the fence member 602 that is orthogonal to the first surface of the fence member 602. In addition, the seventh member 234 and the eight member 238 are also in contact with the second surface of the fence member 602. In this instance, the first elongated member 228 and the second elongated member 244 are disposed along a third surface of the fence member 602 and the third surface of the fence member 602 is opposite and parallel to the second surface of the fence member 602.

FIG. 6C illustrates the feeding bucket 200 mounted on a nail/hook 604 that is located on a wall in accordance with the principles of the present disclosure. In this instance, the hook portion 236 is placed over the nail/hook 604 that bucket 200 is suspended along the wall. Due to the unique design, the handle 204 may provide extra support to the bucket 200 while it is hanging on the hook 604. For example, in this application, the seventh member 234 and the eight member 238 may be in contact with the surface of the wall providing extra support for the bucket so that the feeding bucket 200 is stable and does not fall down as the animal is eating the feed in the feeding bucket 200. In yet another embodiment, even the fifth member 232 and the sixth member 242 may be in contact with the surface of the wall further enhancing the support and stability of the feeding bucket 200.

One or more illustrative embodiments of the disclosure have been described above. The above-described embodiments are merely illustrative of the scope of this disclosure and are not intended to be limiting in any way. Accordingly, variations, modifications, and equivalents of the embodiments disclosed herein are also within the scope of this disclosure.

While the present disclosure has been described with reference to a number of embodiments, it will be understood by those skilled in the art that the invention is not limited to such disclosed embodiments. Rather, the disclosure can be modified to incorporate any number of variations, alterations, substitutions, or equivalent arrangements not described herein, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description but is only limited by the scope of the appended claims.

What is claimed is:

1. A container comprising:
a housing having a first end and a second end; and
a lid couplable to the first end of the housing, the housing comprising:
a lip structure disposed at the first end of the housing;
a plurality of locking structures disposed within the lip structure;
a plurality of recessed regions disposed within the lip structure; and
an engagement feature disposed within each of the plurality of the locking structures and the plurality of recessed regions.

2. The container of claim 1, wherein each of the plurality of locking structures further comprising an opening disposed within the locking structure.

3. The container of claim 1, wherein the engagement feature further comprises:
a first portion having a first end and an opposing second end; and
a second portion coupled at the second end of the first portion and being orthogonal to the first portion.

4. The container of claim 3, wherein the first portion has a gradient along a direction from the first end to the second end.

5. The container of claim 4, wherein the gradient is highest at the second end.

6. The container of claim 1, wherein the lid comprises a front surface and an opposing back surface, the lid further comprising:
a set of first ribs extending between a ring structure and an edge of the lid;
a set of second ribs extending between the ring structure and the edge of the lid, wherein the set of first ribs is different from the set of second ribs.

7. The container of claim 6, wherein:
the set of the first ribs each has a first end and an opposing second end and wherein the second end is characterized by a first thickness;
the set of the second ribs each has a third end and an opposing fourth end and wherein the fourth end is characterized by a second thickness, wherein the second thickness is greater than the first thickness.

8. The container of claim 7, wherein the fourth end of each of the set of second ribs is in contact with the corresponding engagement feature when the lid is secured to the housing.

9. The container of claim 8, wherein the second end of each of the set of first ribs is in contact with a surface of the lip structure when the lid is secured to the housing.

10. The container of claim 1, wherein the lid comprises a front surface and an opposing back surface, the lid further comprising:
a plurality of stacking features arranged in a circular pattern on the front surface;
a plurality of handle structures located towards a center of the lid on the front surface; and
a ring structure disposed on the back surface, wherein the ring structure is disposed between the plurality of stacking features and the plurality of handle structures.

11. The container of claim 10, wherein the lid further comprises a plurality of ribs disposed on the back surface and each of the plurality of the ribs extends from the ring structure towards an edge of the lid and traverses at least one stacking feature of the plurality of stacking features.

12. The container of claim 10, wherein the plurality of the stacking features define an area and wherein the plurality of the handle structures are disposed within the area.

13. The container of claim 1, wherein the lid comprises a plurality of locking portions that algin with a respective recessed region of the plurality of recessed regions when the lid is secured to the housing.

14. A feeding bucket comprising:
a housing having a plurality of handle connection points; and
a handle connected to the plurality of handle connection points, wherein the handle comprises:
a first curved portion attached to one of the plurality of handle connection points;
a first elongated member coupled to the first curved portion;
a second member coupled to the first elongated member;
a third member coupled to the second member;
a fourth member coupled to the third member; and
a hook portion coupled to the fourth member, wherein:
the first elongated member forms a first angle with the second member; and
the second member is orthogonal to the third member.

15. The feeding bucket of claim 14, the handle further comprising:
a fifth member coupled to the hook portion;
a sixth member coupled to the fifth member;
a seventh member coupled to the sixth member;
a second elongated member coupled to the seventh member; and
a second curved portion coupled to the second elongated member.

16. The feeding bucket of claim 15, wherein:
the second elongated member forms a second angle with the seventh member;
the seventh member is orthogonal to the sixth member; and
the sixth member is orthogonal to the fifth member.

17. The feeding bucket of claim 15, wherein:
the second member is parallel to the seventh member; and
the third member is parallel to the sixth member.

18. The feeding bucket of claim 15, wherein the first elongated member is parallel to the second elongated member.

19. The feeding bucket of claim 14, wherein the first angle is in a range of between 0 deg and 90 deg.

20. The feeding bucket of claim 14, wherein the feeding bucket is characterized by a radius and wherein a length of the first elongated member is greater than the radius.
